(19) United States
(12) Patent Application Publication
(10) Pub. No.: US 2026/0365103 A1
(43) Pub. Date: Nov. 19, 2026

(54) Vehicle Roof

(71) Applicant: Mercedes-Benz Group AG, Stuttgart (DE)

(72) Inventor: Achim DEMMER, Magstadt (DE)

(21) Appl. No.: 19/135,701

(22) PCT Filed: Oct. 19, 2023
(86) PCT No.: PCT/EP2023/079187

§ 371 Date: Jun. 4, 2025

(30) Foreign Application Priority Data
Dec. 5, 2022 (DE) 10 2022 004 538.9

(51) Int. Cl. B60Q 3/51; B60Q 3/20; B60Q 3/60; B60R 13/02

(52) U.S. Cl. CPC B60Q 3/51; B60Q 3/20; B60Q 3/60; B60R 13/0212

(57) ABSTRACT

A vehicle roof has a headliner, a frame, and a glass surface disposed in the frame. The glass surface is subdivided into a rectangular transparent see-through surface and a rectangular non-transparent edge surface adjoining the rectangular transparent see-through surface peripherally in an edge region. An opaque elongated carrier body is disposed on the rectangular non-transparent edge surface in the edge region and adjacent to the rectangular transparent see-through surface. A light emitting diode (LED) module having a plurality of LEDs is disposed on an upper side of the opaque elongated carrier body. A plurality of fastening elements are moulded on an underside of the opaque elongated carrier body. The opaque elongated carrier body is fastenable in the headliner by the plurality of fastening elements.

### BACKGROUND AND SUMMARY OF THE INVENTION

The invention relates to a vehicle roof.

Often a glass surface is formed in vehicle roofs of vehicles, which is referred to as a panorama roof or a glass roof, for example. This glass surface can also be connected to an optical unit for lighting.

In this regard, EP 3 744 544 A1 describes a vehicle in which a glass pane with a frame is integrated into a vehicle roof. An elongated lighting device is connected to the frame and configured in such a way that the passenger compartment of the vehicle is directly illuminated.

Furthermore, DE 10 2018 116 340 A1 discloses a vehicle roof system in which a three-dimensional upright image is generated in the vehicle interior by an optical unit arranged in the roof frame.

The object of the invention is to specify a generic vehicle roof in which illumination of a glass surface of the vehicle roof is enabled in a simple and advantageous manner.

According to the invention, in the vehicle roof having a glass surface provided in a frame in the vehicle roof, this glass surface is subdivided into a rectangular transparent see-through surface and a rectangular non-transparent edge surface adjoining the rectangular transparent see-through surface at the periphery. In the edge region of the rectangular, non-transparent edge surface, an opaque elongated carrier body is arranged on both longitudinal sides of the rectangular, non-transparent edge surface adjacent to the rectangular, transparent see-through surface on the rectangular, non-transparent edge surface, which preferably extends over the entire longitudinal side of the rectangular, transparent see-through surface.

On the upper side of both of these opaque elongated carrier bodies, an optical unit, or a light emitting diode (LED) module with a plurality of LEDs, is arranged, whose emitted radiation is fed into the rectangular transparent see-through surface of the glass surface. The opaque elongated carrier body, which acts as a shield, prevents the radiation emitted by the LEDs of the two LED modules from entering the vehicle interior.

Furthermore, several fastening elements are moulded onto the underside of the opaque elongated support body for fastening the opaque elongated support body in the headliner or in the roof panelling of the vehicle roof. These fastening elements are preferably designed as fastening hooks that engage in corresponding receptacles in the headliner or in the roof panelling of the vehicle roof, for example by being clipped into these receptacles in the headliner or in the roof panelling of the vehicle roof.

In the case of an LED module as an optical unit, at least 20 LEDs are preferably provided, for example at least 30 LEDs, which are arranged spaced apart from each other on the opaque elongated carrier body. For example, the LEDs of an LED module are arranged equidistantly from one another and, for example, glued to the opaque elongated carrier body.

At least 5 fastening elements, for example at least 7 fastening elements, are preferably provided for fastening the respective opaque elongated carrier body in the headliner or in the roof panelling of the vehicle roof, which are moulded onto the respective opaque elongated carrier body spaced apart from one another and thus form a single-piece unit with it. For example, the fastening elements moulded onto the respective opaque elongated carrier body are arranged equidistant from one another.

The respective opaque elongated carrier body is preferably made of an opaque plastic, for example polypropylene (PP) or acrylonitrile butadiene styrene (ABS).

The respective rectangular, opaque, elongated carrier body is preferably fastened to the rectangular, non-transparent edge surface of the glass roof in the edge region of the rectangular, non-transparent edge surface of the glass roof by means of an opaque fastening element, in particular glued by means of an opaque glue at specific adhesive points on the rectangular, non-transparent edge surface of the glass roof. The opaque fastening element acting as a shield, for example the opaque glue, prevents the radiation emitted by the LEDs of the two LED modules from escaping laterally from the opaque elongated carrier body as scattered radiation to undesired points.

For the planar distribution of the radiation of the LEDs of the respective LED module, which are fed into the rectangular transparent see-through surface of the glass roof, optical scattering elements formed as optical prisms are provided, for example, in the glass roof, preferably in the edge region between the rectangular non-transparent edge surface of the glass roof and the rectangular transparent see-through surface of the glass roof. The radiation of the LEDs of the respective LED modules fed into the rectangular transparent see-through surface of the glass roof are homogeneously distributed by this optical scattering element in the rectangular transparent see-through surface of the glass roof, such that the entire surface of the rectangular transparent see-through surface of the glass roof is advantageously illuminated and also homogeneously illuminated. Here, the LEDS of the two LED modules are chosen or actuated appropriately, in such a way that any color chosen by a user can be set or specified as desired for the radiation fed into the rectangular transparent see-through surface of the glass roof.

In an advantageous development of the invention, a respective opaque elongated carrier body is subdivided into at least two carrier segments arranged spaced apart from each other, for example into four carrier segments arranged spaced apart from one another, which then together form the functionality of a single opaque elongated carrier body. This subdivision of the opaque elongated carrier body into individual carrier segments is chosen according to the (geometric) circumstances of the vehicle roof and depends on the radiation coupling to be realized for the radiation emitted by the LEDs of the respective LED module and their control.

In particular, each of the carrier segments realized in such a way are assigned at least 5 LEDs, whose emitted radiation is then fed in a specific region into the rectangular transparent see-through surface of the glass roof. In particular, each carrier segment realized in such a way has at least two fastening elements formed on it for fastening in the headliner or in the roof lining of the vehicle roof and is glued to the rectangular, non-transparent edge surface of the glass roof by means of an opaque glue at specific adhesive points in a specific section of the edge area of the rectangular, non-transparent edge surface of the glass roof adjacent to the rectangular, transparent glass surface of the vehicle roof.

Advantageously, in the vehicle roof according to the invention, the opaque elongated carrier body can integratively realize both a receiving possibility for the LED module provided for radiation emission into the rectangular transparent see-through surface of the glass roof and a fastening possibility for the glass surface of the vehicle roof in the headliner or in the roof panelling of the vehicle roof, thereby saving otherwise required installation space, in particular in the transverse direction of the vehicle roof.

As a result, a larger area can also be provided in the vehicle roof as a rectangular transparent see-through surface of the glass roof and, in particular, the area provided for lighting in the vehicle roof can also be increased, which in turn can also benefit users of the vehicle.

Further advantages, features and details of the invention can be seen from the following description of a preferred embodiment and from the drawings. The features and combinations of features mentioned above in the description as well as the features and combinations of features mentioned below in the description of the figures and/or shown alone in the two figures can be used not only in the combination indicated in each case, but also in other combinations or on their own, without leaving the scope of the invention.

### BRIEF DESCRIPTION OF THE DRAWINGS

FIG. 1 is a schematic view from below onto a section of vehicle roof with an integrated glass surface; and

FIG. 2 is a schematic sectional view of the vehicle roof with an integrated glass surface.

### DETAILED DESCRIPTION OF THE DRAWINGS

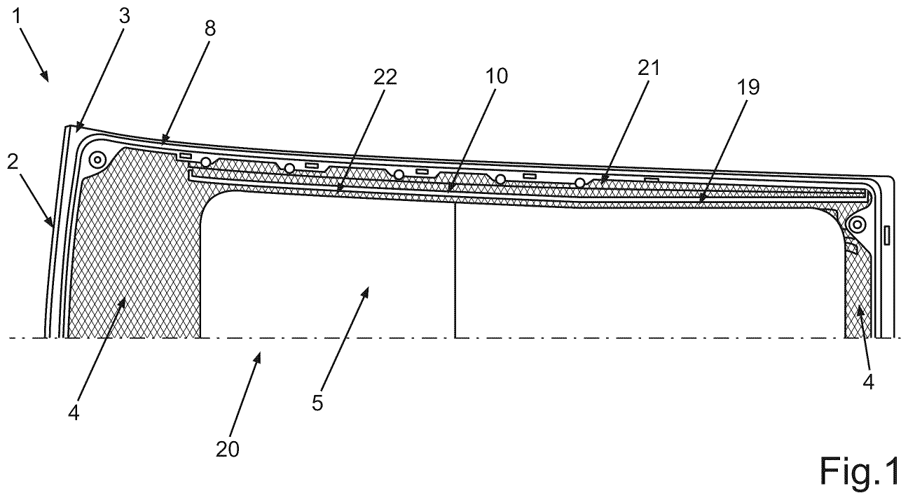

According to FIG. 1, showing a section of a vehicle roof 1, in this vehicle roof 1, a rectangular insert 2 with dimensions of, for example, approx. 1800 mm×1150 mm is introduced into the vehicle roof 1.

This rectangular insert 2 has a rectangular frame 3, for example made of plastic, on which an adhesive bead 8 is applied all round, by means of which the rectangular insert 2 can be fixed to the chassis of the vehicle by gluing.

Furthermore, a rectangular glass surface 20 is provided in the rectangular insert 2 or in the rectangular frame 3, which has a rectangular transparent see-through surface 5 and a rectangular non-transparent edge surface 4 adjoining the rectangular transparent see-through surface 5 peripherally in the edge region 19, for example by means of black printing. The rectangular, non-transparent edge surface 4 of the glass surface 20 has, for example, a width of 100 mm to 120 mm on each of the two longitudinal sides 22 of the rectangular transparent see-through surface 5 of the glass surface 20, such that the rectangular transparent see-through surface 5 of the glass surface 20 consequently has a width of, for example, approx. 900 mm to 950 mm. On the two broadsides of the rectangular transparent see-through surface 5 of the glass surface 20, the length of the rectangular non-transparent edge surface 4 of the glass surface 20 on the front broadside of the rectangular transparent see-through surface 5 of the glass surface 20 seen in the longitudinal direction of the vehicle is, for example, approx. 100 mm to 150 mm and on the rear broadside of the rectangular transparent see-through surface 5 of the glass surface 20 as seen in the longitudinal direction of the vehicle, for example approx. 50 mm to 100 mm, so that the rectangular transparent see-through surface 5 of the glass surface 20 consequently has a length of, for example, approx. 1600 mm.

In the edge region 19 between the rectangular transparent see-through surface 5 of the glass surface 20 and the rectangular non-transparent edge surface 4 of the glass surface 20, an opaque elongated carrier body 10 is applied to the rectangular non-transparent edge surface 4 of the glass surface 20 on each of the two longitudinal sides 21 of the rectangular non-transparent edge surface 4 of the glass surface 20 and thus adjacent to the rectangular transparent see-through surface 5 of the glass surface 20. According to FIG. 1, this opaque elongated carrier body 10 extends, for example, along the entire longitudinal side 22 of the rectangular transparent see-through surface 5 of the glass surface 20.

In one embodiment shown in FIG. 1, the opaque elongated carrier body 10 is designed as a one-piece component. However, the opaque elongated carrier body 10 can also be divided into two carrier segments arranged spaced apart from each other or into several carrier segments arranged spaced apart from one another.

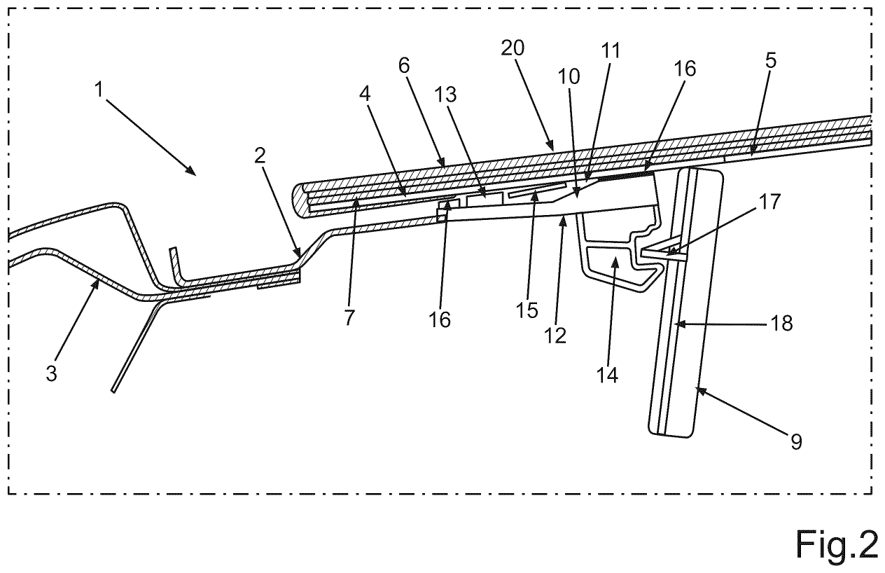

In the sectional view according to FIG. 2, it can be seen that a respective elongated carrier body 10, for example consisting of an opaque plastic, for example a respective elongated carrier body 10 consisting of an ABS plastic (acrylonitrile-butadiene-styrene), is glued to the rectangular non-transparent edge surface 4 of the glass surface 20 at adhesive points 16. The glass surface 20 is formed as laminated glass with an outer glass pane 6 and an inner glass pane 7, wherein the inner glass pane 7 is black printed in the region of the rectangular, non-transparent edge surface 4 of the glass surface 20 and is thus formed opaque.

An LED module 13 with a large number of LEDs arranged equidistantly is, for example, provided on the upper side 11 of the respective opaque elongated carrier body 10. For example, 30 LEDs are provided in an LED module 13, which emit optical radiation in a specific wavelength range, by means of which any adjustable coloring can be specified by corresponding control of the LEDs. In particular, a user can also select the respective color scheme according to their wishes and preferences. For example, an LED module 13 has a length of 1000 mm to 1200 mm, a width of 20 mm to 30 mm and a height of 20 mm.

The optical radiation emitted by the LEDs of the two LED modules 13 is introduced into the rectangular transparent see-through surface 5 of the glass surface 20 by optical scattering elements designed as prisms 15 and is homogeneously distributed therein in the rectangular transparent see-through surface 5 of the glass surface 20 by scattering effects, so that the entire rectangular transparent see-through surface 5 of the glass surface 20 adjoining the rectangular non-transparent edge surface 4 of the glass surface 20 is also homogeneously illuminated.

In addition to fastening the opaque, elongated carrier body 10 to the rectangular, non-transparent edge surface 4 of the glass surface 20, the adhesive points 16 are also intended to protect the LEDs of the respective LED module 13 from damage and the effects of the weather and to prevent scattered light from the LEDs of the respective LED module 13 that leads to radiation losses and does not contribute to the optical radiation of the LEDs of the respective LED module 13 that is fed into the rectangular, transparent see-through surface 5 of the glass surface 20.

On the underside 12 of the respective opaque elongated carrier body 10, several fastening elements 14, for example in the form of fastening hooks, are moulded on. For example, 7 such fastening hooks 14 are moulded in one piece equidistantly on a respective elongated carrier body 10.

As can be seen in FIG. 2, the fastening hooks 14 engage in corresponding receptacles 17 provided in the headliner 9 of the vehicle roof 1, which is designed for example as a fabric-laminated or leather-laminated plastic part, and thus lock the glass surface 20 and consequently also the entire insert 2 in the headliner 9 of the vehicle roof 1. The respective receptacle 17 in the headliner 9 of the vehicle roof 1 is connected to a reinforcing element 18 integrated in the headliner 9 for stabilization.

If the opaque elongated carrier body 10 is divided into two spaced-apart carrier segments or into several spaced-apart carrier segments, each of the carrier segments is designed to accommodate a certain number of LEDs and to be fastened in the headliner 9 or in the roof panelling of the vehicle roof 1 and is designed accordingly. Taken together, the individual carrier segments as a whole then assume the functionality of a one-piece, opaque, elongated carrier body 10 with regards to accommodating an optical unit for emitting optical radiation into the rectangular transparent see-through surface 5 of the glass surface 20 and with regards to fastening the insert 2 in the roof lining 9 or in the roof panelling of the vehicle roof 1.

1.-10. (canceled)

11. A vehicle roof (1), comprising:
a headliner (9);
a frame (3);
a glass surface (20) disposed in the frame (3), wherein the glass surface (20) is subdivided into a rectangular transparent see-through surface (5) and a rectangular non-transparent edge surface (4) adjoining the rectangular transparent see-through surface (5) peripherally in an edge region (19) between the rectangular transparent see-through surface (5) and the rectangular non-transparent edge surface (4);
an opaque elongated carrier body (10), wherein the opaque elongated carrier body (10) is disposed on the rectangular non-transparent edge surface (4) in the edge region (19) and adjacent to the rectangular transparent see-through surface (5);
a light emitting diode (LED) module (13) having a plurality of LEDs, wherein the light emitting diode (LED) module (13) is disposed on an upper side (11) of the opaque elongated carrier body (10); and
a plurality of fastening elements (14), wherein the plurality of fastening elements (14) are moulded on an underside (12) of the opaque elongated carrier body (10) and wherein the opaque elongated carrier body (10) is fastenable in the headliner (9) by the plurality of fastening elements (14).

12. The vehicle roof (1) according to claim 11, wherein the LED module (13) has at least 20 LEDs disposed spaced apart from one another.

13. The vehicle roof (1) according to claim 11, wherein the plurality of fastening elements (14) comprise at least 5 fastening elements (14) disposed spaced apart from one another.

14. The vehicle roof (1) according to claim 11, wherein an opaque glue is applied to the opaque elongated carrier body (10).

15. The vehicle roof (1) according to claim 11, wherein the opaque elongated carrier body (10) is adhered onto the rectangular non-transparent edge surface (4) by an opaque glue at adhesive joints (16).

16. The vehicle roof (1) according to claim 11, wherein the glass surface (20) has a plurality of optical scattering elements (15) for a planar distribution of radiation of the plurality of LEDs that is fed into the rectangular transparent see-through surface (5).

17. The vehicle roof (1) according to claim 11, wherein each of the plurality of fastening elements (14) is a hook.

18. The vehicle roof (1) according to claim 11, wherein the opaque elongated carrier body (10) is subdivided into at least two carrier segments disposed spaced apart from each other.

19. The vehicle roof (1) according to claim 18, wherein at least one carrier segment of the at least two carrier segments has at least two fastening elements (14).

20. The vehicle roof (1) according to claim 18, wherein at least one carrier segment of the at least two carrier segments has at least 5 LEDs.
